(19) United States
(12) Patent Application Publication
(10) Pub. No.: US 2006/0090299 A1
(43) Pub. Date: May 4, 2006

(54) Device with retractable handle structure

(75) Inventor: Shu-Ju Liao, Yingge Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/255,388

(22) Filed: Oct. 21, 2005

(30) Foreign Application Priority Data
Nov. 2, 2004 (TW) 93133331

(51) Int. Cl. E05B 1/00

(52) U.S. Cl. 16/405

(57) ABSTRACT

A device with a retractable handle structure. The device comprises a body, a handle portion, first and second retractable portions, and two springs. The handle portion comprises two end portions, each with an opening. The first and second retractable portions are extended toward an inner cavity of the handle portion via the openings respectively. Each retractable portion comprises a respective connection portion. The springs are disposed respectively between each of the connection portion and the opposite end portion. When the handle portion is in a retracted position, the first and second connection portions are separate. When the handle portion is positioned in a holding position, the first and second connection portions abut against each other to limit movement of the first and second retractable portions, and the first and second springs employ elastic forces to the handle portion to move toward the retracted position from the holding position.

### BACKGROUND

The present invention relates to a device with retractable handle structure.

A device or an object comprises a handle structure, enabling a user to hold the device or the object. FIG. 1A shows a conventional handle structure, comprising a handle portion 210 and a body 280. Each end of the handle portion 210 is connected to the body 280 by a connection portion 220.

In the conventional handle structure, the connection portions 220 are fixed, and the handle portion 210 extrudes on the body 280, occupying an additional space. In order to reduce the space occupied by the handle portion 210, a conventional retractable handle structure is introduced.

FIG. 1B shows an example of the conventional retractable handle structure, in which the handle portion 210 comprises a hollow structure, and a plurality of retractable portions 230 are employed to connect the handle portion 210 and the body 280. When the handle structure is not in operation, the retractable portions 230 can be retracted to the handle portion 210, and the handle portion 210 is hidden in a cavity on the body 280, thereby reducing the space occupied.

The retractable handle structure in FIG. 1B, however, requires an external force in the retracting motion of the retractable portions 230. Specifically, the user needs to manually push the handle portion 210 to the cavity on the body 280 to retract the retractable portions 230 to the handle portion 210, which is inconvenient.

In an embodiment of the invention, a retractable handle structure for handling an object, such as a device with the retractable handle structure, is provided. The retractable handle structure comprises a handle portion, first and second retractable portions, and first and second springs. The handle portion comprises a first end portion, a second end portion and an inner cavity, the inner cavity connects to a first opening on the first end portion and a second opening on the second end portion. The first and second retractable portions are extended toward the inner cavity via the first and second openings respectively. The first retractable portion comprises a first connection portion, and the second retractable portion comprises a second connection portion. The first spring is disposed between the first connection portion and the second end portion, and the second spring is disposed between the second connection portion and the first end portion. When the handle portion is in a retracted position, the first and second retractable portions retract to the inner cavity and the first and second connection portions are separate. When the handle portion is positioned in a holding position, the first and second retractable portions reach out from the inner cavity, the first and second connection portions abut against each other to limit movement of the first and second retractable portions, and the first and second springs employ elastic forces to the handle portion to move toward the retracted position from the holding position.

In some embodiments, the first and second retractable portions can be respectively deflectable strip structures, the first and second connection portions can respectively comprise engaging hooks, and the handle portion can be hollow tube-shaped.

A detailed description is given in the following embodiments with reference to the accompanying drawings.

### DESCRIPTION OF THE DRAWINGS

The present invention can be more fully understood by reading the subsequent detailed description and examples with references made to the accompanying drawings, wherein:

FIG. 1A is a schematic view of a conventional handle structure;

FIG. 1B is a schematic view of a conventional retractable handle structure;

FIG. 2 is a schematic view of a retractable handle structure of a first embodiment of the invention;

FIG. 3A is a cross-sectional view of FIG. 2 when the handle portion is in the retracted position;

FIG. 3B is a cross-sectional view of FIG. 2 when the handle portion is in the holding position;

FIG. 4 is a schematic view of a retractable handle structure of a second embodiment of the invention;

FIG. 5A is a cross-sectional view of FIG. 4 when the handle portion is in the retracted position; and

FIG. 5B is a cross-sectional view of FIG. 4 when the handle portion is in the holding position.

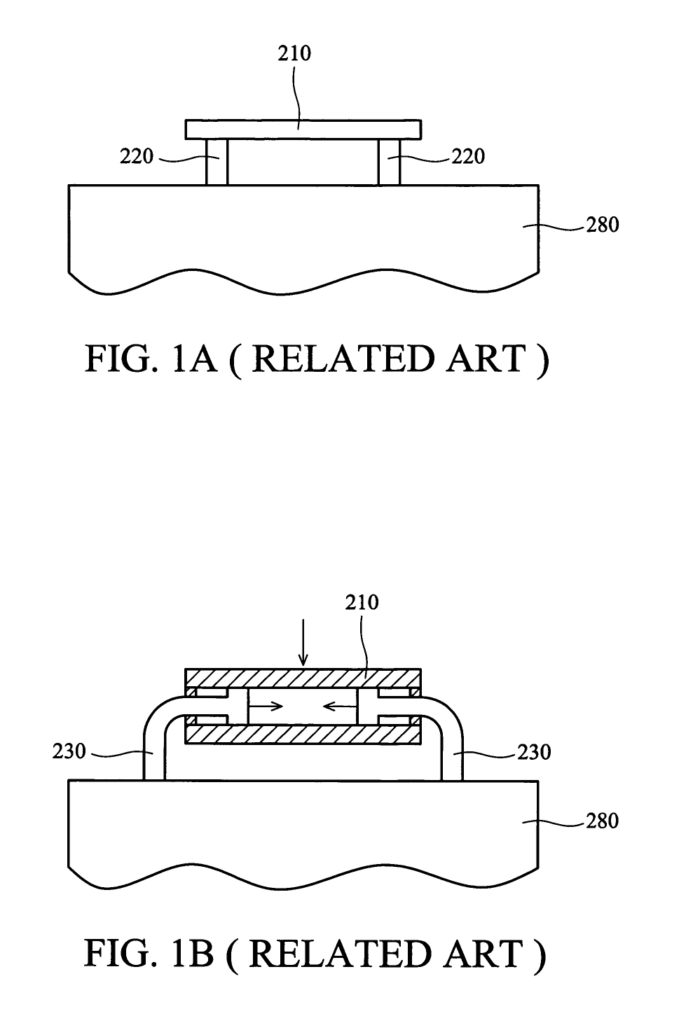

### DETAILED DESCRIPTION

### First Embodiment

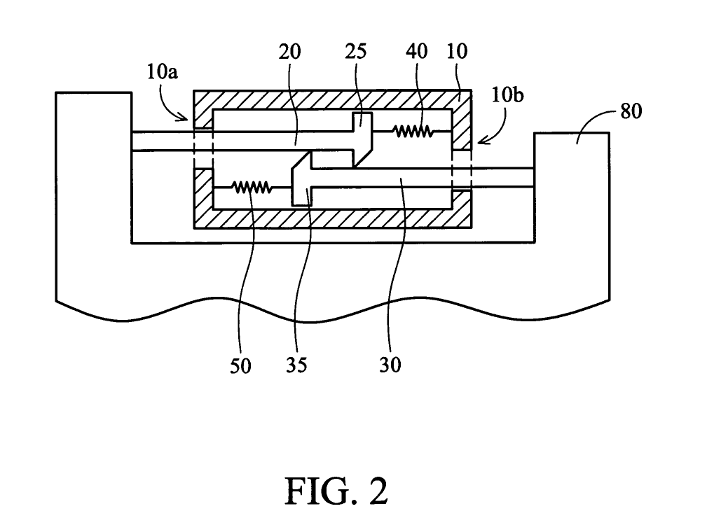

FIG. 2 shows a first embodiment of a retractable handle structure for holding an object. In FIG. 2, the retractable handle structure comprises a handle portion 10, a first retractable portion 20, a second retractable portion 30, a first spring 40, and a second spring 50.

The handle portion 10 is a hollow tube. The shape of the handle portion 10 can be a shape suited to holding, such as the oval shape shown in FIG. 2. The handle portion 10 comprises a first end portion 10a and a second end portion 10b. A first opening is disposed on the first end portion 10a, and a second opening is disposed on the second end portion 10b. An inner cavity of the handle portion 10 connects to the first opening 10a and the second opening 10b.

The first and second retractable portions 20 and 30 are deflectable strip structures, extended respectively toward the inner cavity of the handle portion 10 via the first opening 10a and the second opening 10b. One end of the first and second retractable portions 20 and 30 connects to the body 80 of the object. The other end of the first retractable portion 20 comprises a first connection portion 25, and the other end of the second retractable portion 30 comprises a second connection portion 35. The first and second connection portions 25 and 35 can respectively comprise abutting portions, such as engaging hooks.

The first spring 40 is disposed between the first connection portion 25 and the second end portion 10b, and the second spring 50 is disposed between the second connection portion 35 and the first end portion 10a.

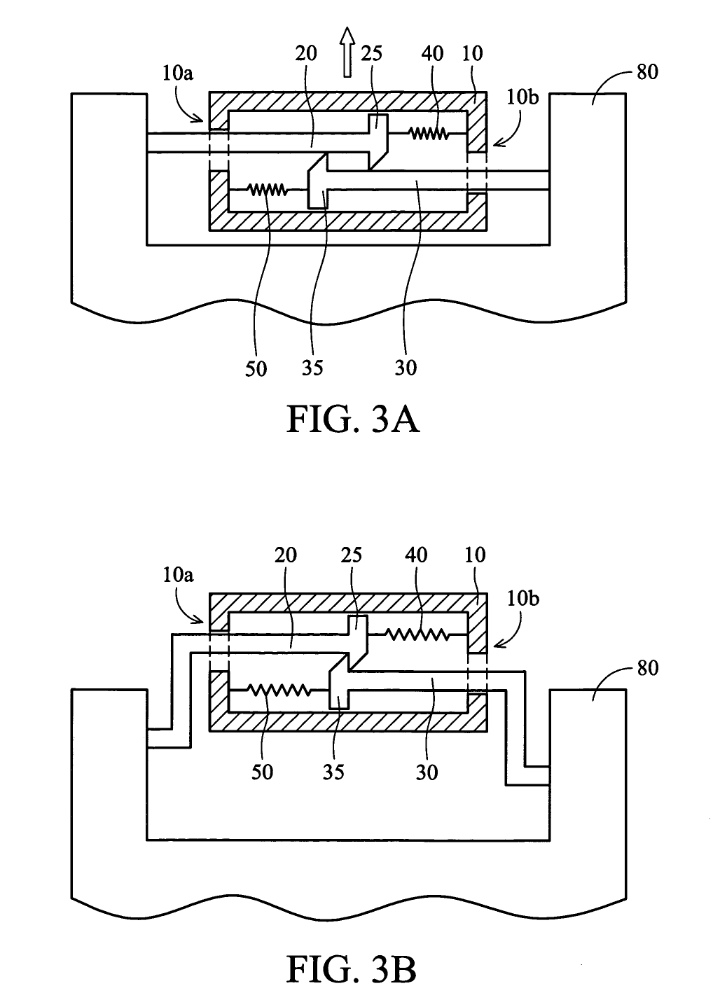

FIG. 3A and FIG. 3B show embodiments of the different positions of the handle portion 10 in FIG. 2. As shown in FIG. 3A, the handle portion 10 is in a retracted position. In this case, the first and second retractable portions 20 and 30 retract to the inner cavity due to the elastic forces of the first and second springs 40 and 50, and the first and second connection portions 25 and 35 are separate.

As shown in FIG. 3B, the handle portion 10 is moved in a holding position. Specifically, the handle portion 10 needs to be held by an external force, such as being held by a user, to maintain in the holding position. In this case, the first and second retractable portions 20 and 30 reach out from the inner cavity, and the first and second connection portions 25 and 35 abut against each other to limit movement of the first and second retractable portions 20 and 30. Further, the first and second springs 40 and 50 are stretched by the first and second retractable portions 20 and 30, and employ elastic forces to the first and second retractable portions 20 and 30, which intend to force the handle portion 10 to move toward the retracted position from the holding position. Thus, the handle portion 10 automatically moves toward the retracted position due to the elastic forces when released by the user.

The retractable handle structure can be employed to any device requiring handling. With the retractable handle structure, the handle portion 10 automatically moves toward the retracted position due to the elastic forces when released by the user. Accordingly, the user does not need to manually push the handle portion 10 to the retracted position, which is inconvenient.

In some embodiments, the size and shape of the handle portion 10 and the first and second retractable portion can be preferably defined for easy handling for human.

### Second Embodiment

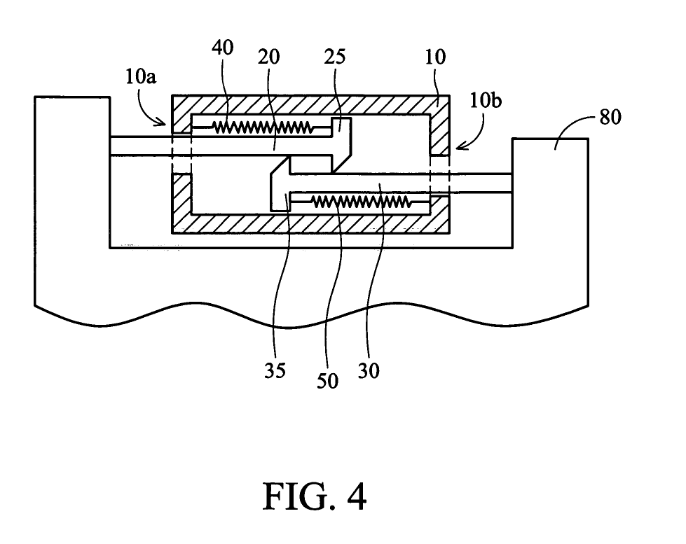

FIG. 4 shows a second embodiment of a retractable handle structure. The difference between the second embodiment and the above-mentioned first embodiment is the position of the springs; In the first embodiment as shown in FIG. 2, the first spring 40 is disposed between the first connection portion 25 and the second end portion 10b, and the second spring 50 is disposed between the second connection portion 35 and the first end portion 10a. Thus, the handle portion 10 is retracted from the holding position to the retracted position by pulling with extension elastic forces provided by the first spring 40 and the second spring 50. In the second embodiment as shown in FIG. 4, however, the first spring 40 is disposed between the first connection portion 25 and the first end portion 10a, and the second spring 50 is disposed between the second connection portion 35 and the second end portion 10b. Thus, the handle portion 10 is retracted from the holding position to the retracted position by pushing with the compression elastic force provided by the first spring 40 and the second spring 50.

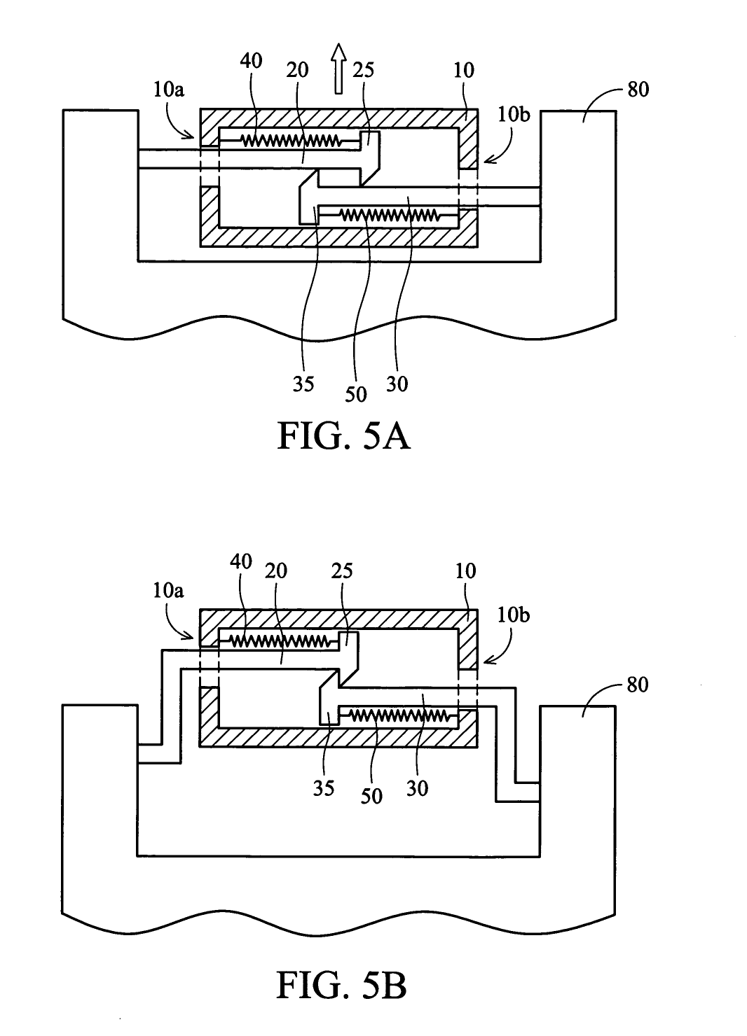

FIG. 5A and FIG. 5B show embodiments of the different positions of the handle portion 10 in FIG. 4. As shown in FIG. 5A, the handle portion 10 is in a retracted position. In this case, the first and second retractable portions 20 and 30 retract to the inner cavity due to the compression elastic forces of the first and second springs 40 and 50, and the first and second connection portions 25 and 35 are separate.

As shown in FIG. 5B, the handle portion 10 is moved in a holding position. Specifically, the handle portion 10 needs to be held by an external force, such as being held by a user, to maintain in the holding position. In this case, the first and second retractable portions 20 and 30 reach out from the inner cavity, and the first and second connection portions 25 and 35 abut against each other to limit movement of the first and second retractable portions 20 and 30. Further, the first and second springs 40 and 50 are compressed by the first and second retractable portions 20 and 30, and employ compression elastic forces to the first and second retractable portions 20 and 30, which intend to force the handle portion 10 to move toward the retracted position from the holding position. Thus, the handle portion 10 automatically moves toward the retracted position due to the elastic forces when released by the user.

The retractable handle structure can be employed to any device requiring handling. With the retractable handle structure, the handle portion 10 automatically moves toward the retracted position due to the elastic forces when released by the user. Accordingly, the user does not need to manually push the handle portion 10 to the retracted position, which is inconvenient.

In some embodiments, the size and shape of the handle portion 10 and the first and second retractable portion can be preferably defined for easy handling for human.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A device with a retractable handle structure, comprising:
a body;
a handle portion having a first end portion, a second end portion and an inner cavity, the inner cavity connects to a first opening on the first end portion and a second opening on the second end portion;
a first retractable portion extended toward the inner cavity via the first opening, one end of the first retractable portion connecting to the body, the other end of the first retractable portion comprising a first connection portion;
a second retractable portion extended toward the inner cavity via the second opening, one end of the second retractable portion connecting to the body, the other end of the second retractable portion comprising a second connection portion corresponding to the first connection portion;
a first spring disposed between the first connection portion and the second end portion; and
a second spring disposed between the second connection portion and the first end portion;
wherein, when the handle portion is in a retracted position, the first and second retractable portions retract to the inner cavity;
when the handle portion is positioned in a holding position, the first and second retractable portions reach out from the inner cavity, and the first and second springs employ elastic forces to the handle portion to move toward the retracted position from the holding position.

2. The device with a retractable handle structure as claimed in claim 1, wherein the first and second retractable portions are respectively deflectable strip structures.

3. The device with a retractable handle structure as claimed in claim 1, wherein the first and second connection portions respectively comprise abutting portions, the first and second connection portions are separate when the handle portion is in the retracted position, and the first and second connection portions abut against each other by the abutting portions to limit movement of the first and second retractable portions when the handle portion is positioned in the holding position.

4. The device with a retractable handle structure as claimed in claim 3, wherein the first and second connection portions respectively comprise engaging hooks.

5. The device with a retractable handle structure as claimed in claim 1, wherein the handle portion is hollow tube-shaped.

6. A retractable handle structure for handling an object, the retractable handle structure comprising:
a handle portion having a first end portion, a second end portion and an inner cavity, the inner cavity connects to a first opening on the first end portion and a second opening on the second end portion;
a first retractable portion extended toward the inner cavity via the first opening, one end of the first retractable portion connecting to the object, the other end of the first retractable portion comprising a first connection portion;
a second retractable portion extended toward the inner cavity via the second opening, one end of the second retractable portion connecting to the object, the other end of the second retractable portion comprising a second connection portion corresponding to the first connection portion;
a first spring disposed between the first connection portion and the first end portion; and
a second spring disposed between the second connection portion and the second end portion;
wherein, when the handle portion is in a retracted position, the first and second retractable portions retract to the inner cavity;
when the handle portion is positioned in a holding position, the first and second retractable portions reach out from the inner cavity, and the first and second springs employ elastic forces to the handle portion to move toward the retracted position from the holding position.

7. The retractable handle structure as claimed in claim 6, wherein the first and second retractable portions are respectively deflectable strip structures.

8. The retractable handle structure as claimed in claim 6, wherein the first and second connection portions respectively comprise abutting portions, the first and second connection portions are separate when the handle portion is in the retracted position, and the first and second connection portions abut against each other by the abutting portions to limit movement of the first and second retractable portions when the handle portion is positioned in the holding position.

9. The retractable handle structure as claimed in claim 8, wherein the first and second connection portions respectively comprise engaging hooks.

10. The retractable handle structure as claimed in claim 6, wherein the handle portion is hollow tube-shaped.

11. A device with a retractable handle structure, comprising:
a body;
a handle portion having a first end portion, a second end portion and an inner cavity, the inner cavity connects to a first opening on the first end portion and a second opening on the second end portion;
a first retractable portion extended toward the inner cavity via the first opening, one end of the first retractable portion connecting to the body, the other end of the first retractable portion comprising a first connection portion;
a second retractable portion extended toward the inner cavity via the second opening, one end of the second retractable portion connecting to the body, the other end of the second retractable portion comprising a second connection portion corresponding to the first connection portion;
a first spring disposed between the first connection portion and the first end portion; and
a second spring disposed between the second connection portion and the second end portion;
wherein, when the handle portion is in a retracted position, the first and second retractable portions retract to the inner cavity;
when the handle portion is positioned in a holding position, the first and second retractable portions reach out from the inner cavity, and the first and second springs employ elastic forces to the handle portion to move toward the retracted position from the holding position.

12. The device with a retractable handle structure as claimed in claim 11, wherein the first and second retractable portions are respectively deflectable strip structures.

13. The device with a retractable handle structure as claimed in claim 11, wherein the first and second connection portions respectively comprise abutting portions, the first and second connection portions are separate when the handle portion is in the retracted position, and the first and second connection portions abut against each other by the abutting portions to limit movement of the first and second retractable portions when the handle portion is positioned in the holding position.

14. The device with a retractable handle structure as claimed in claim 13, wherein the first and second connection portions respectively comprise engaging hooks.

15. The device with a retractable handle structure as claimed in claim 11, wherein the handle portion is hollow tube-shaped.
